(19) United States
(12) Patent Application Publication
(10) Pub. No.: US 2016/0070301 A1
(43) Pub. Date: Mar. 10, 2016

(54) LENTICULAR LENS CASE FOR TABLET COMPUTER

(71) Applicant: Ooyavah Inc., Toronto (CA)

(72) Inventors: Odin Cappello, Toronto (CA); Abi Giles, Port Dover (CA); Dimitri Timtchenko, Etobicoke (CA); Keith Millar, Etobicoke (CA); Ihor Petelycky, Toronto (CA)

(21) Appl. No.: 14/479,340

(22) Filed: Sep. 7, 2014

(51) Int. Cl. G06F 1/16; H04M 1/725

(52) U.S. Cl. CPC G06F 1/1637; H04M 1/72522

(57) ABSTRACT

A lenticular lens case for a tablet computer, including first and second base plates that open to enable insertion of a tablet computer, and that close to firmly lock the tablet computer into place, first and second end caps connected to the first and second base plates, including tracks for sliding a frame inwards and outwards, and a lens frame for holding a lenticular lens, including extruding pins that slide along the tracks, such that when the pins reach the end of the tracks, the lens frame can be flipped approximately 180° over the base plates so as to tightly overlay a screen of the tablet computer, when the tablet computer is firmly locked in the base plates.

### FIELD OF THE INVENTION

The present invention relates to cases for tablet computers and, in particular, to cases with lenticular lenses for stereoscopic viewing. The present invention also relates to cases for gaming devices, entertainment devices, web browsers, e-readers, smartphones, and automobile, boat and airplane decks and panels, and to any existing or future slate-type devices.

### BACKGROUND OF THE INVENTION

Lenticular lenses enable specially prepared content to be viewed in stereoscopic 3D, without use of special glasses. Such lenses may be embossed on printed material, and may be overlaid on viewing screens.

When used as overlays on a device viewing screen, lenticular lenslets must be in near-perfect alignment with the screen pixels and sub-pixels; otherwise, distortions are introduced into the 3D content. This requirement is a major technical problem for lenticular lenses that are removable overlays, as these lenses must be repeatedly placed over the screen with near-perfect alignment.

Further, when used as overlays on a device viewing screen, lenticular lenses must have even and tight retention over the screen so that there is not air gap between the lens and the screen; otherwise refraction of light through the air gap introduces distortions into the 3D content. This requirement is another major technical problem for lenticular lenses that are removable overlays.

### SUMMARY OF THE DESCRIPTION

Aspects of the present invention solve the above technical problems with removable lenticular lens overlays, by providing a lenticular lens case for a tablet computer that mechanically aligns and retains the lenticular lens over the screen of the tablet computer, within an accuracy of 0.01 mm, and eliminates an air gap between the lens and the screen.

The lenticular lens case is durable, and makes it easy for a user to accurately attach and remove the lenticular lens.

There is thus provided in accordance with an embodiment of the present invention a lenticular lens case assembly for a tablet computer, including first and second base plates that open to enable insertion of a tablet computer, and that close to firmly lock the tablet computer into place, first and second end caps connected to the first and second base plates, including tracks for sliding a frame inwards and outwards, and a lens frame for holding a lenticular lens, including extruding pins that slide along the tracks, such that when the pins reach the end of the tracks, the lens frame can be flipped approximately 180° over the base plates so as to tightly overlay a screen of the tablet computer, when the tablet computer is firmly locked in the base plates.

### BRIEF DESCRIPTION OF THE DRAWINGS

The present invention will be more fully understood and appreciated from the following detailed description, taken in conjunction with the drawings in which:

FIG. 1 is an exploded view of a lenticular lens case for a tablet computer, in accordance with an embodiment of the present invention;

FIG. 2 is an assembled view of the lenticular lens case of FIG. 1, showing the case used as a stand for the tablet computer, in accordance with an embodiment of the present invention;

FIG. 3 is an illustration of a first base plate of the case of FIG. 1, in accordance with an embodiment of the present invention;

FIG. 4 is an illustration of a second base plate of the case of FIG. 1, in accordance with an embodiment of the present invention;

FIG. 5 is an illustration of a first end cap of the case of FIG. 1, in accordance with an embodiment of the present invention;

FIG. 6 is an illustration of a second end cap of the case of FIG. 1, in accordance with an embodiment of the present invention;

FIG. 7 is an illustration of a lens frame of the case of FIG. 1, in accordance with an embodiment of the present invention;

FIG. 8 is an illustration of a wing bayonet for joining the two base plates of the case of FIG. 1, in accordance with an embodiment of the present invention;

FIG. 9 is a front perspective view of the case of FIG. 1, in accordance with an embodiment of the present invention;

FIG. 10 is a back perspective view of the case of FIG. 1, in accordance with an embodiment of the present invention;

FIG. 11 is a view of the interlocking base plates and end caps of the case of FIG. 1, in accordance with an embodiment of the present invention;

FIG. 12 is a view of a lenticular lens, in the case of FIG. 1, being stored behind a tablet computer, in accordance with an embodiment of the present invention;

FIG. 13 is a view of the lenticular lens frame of the case of FIG. 1, in accordance with an embodiment of the present invention;

FIG. 14 is a view of the magnetic alignment mechanism, for aligning and retaining the lens frame of the case of FIG. 1, in accordance with an embodiment of the present invention;

FIG. 15 is a view of the interior of base plate A and end cap A of the case of FIG. 1, in accordance with an embodiment of the present invention;

FIG. 16 is a view of the magnets molded in base plate A of the case of FIG. 1, in accordance with an embodiment of the present invention;

FIG. 17 is a bottom view of base plate A and end cap A of the case of FIG. 1, in accordance with an embodiment of the present invention; and

FIG. 18 is an animated sequence of pictures showing how the lens frame pulls out and flips over the case of FIG. 1, so as to overlay the lenticular lens array on the screen of the tablet computer, in accordance with an embodiment of the present invention.

For reference to the figures, the following index of elements and their numerals is provided. Similarly numbered elements represent elements of the same type, but they need not be identical elements.

| Element | Description |
|---|---|
| 100 | Entire case |
| 200 | Cover |
| 300 | Base plate A |
| 310 | Rubber grips |
| 320 | Magnet |
| 330 | Male track |
| 340 | Indent |
| 350 | Locking ring |
| 360 | Bayonet thread |
| 370 | Grip |
| 380 | Boss |
| 400 | Base plate B |
| 430 | Female track |
| 450 | Locking ring |
| 460 | Bayonet thread |
| 480 | Boss |
| 500 | End cap A |
| 510 | Cut-out for home button |
| 530 | Track |
| 540 | Perforation |
| 580 | Indent |
| 600 | End cap B |
| 610 | Cut-out for camera |
| 630 | Track |
| 680 | Indent |
| 700 | Lens frame |
| 710 | Pin |
| 720 | Ferrous metal strip |
| 740 | Registration tab |
| 750 | Lens removal tab |
| 800 | Wing bayonet |
| 810 | Metal pin for bayonet |
| 820 | Lock and cover attachment system |
| 900 | Tablet computer |
| 910 | Home button of tablet computer |
| 920 | Camera of tablet computer |
| 930 | Screen of tablet computer |
| 950 | Lenticular lens array |

### DETAILED DESCRIPTION

Aspects of the present invention relate to a lenticular lens case for a tablet computer that mechanically aligns and retains a lenticular lens array over the screen of the tablet computer, within an accuracy of 0.01 mm, and eliminates an air gap between the lens and the screen. The lenticular lens case is durable, and makes it easy for a user to accurately attach and remove the lenticular lens array.

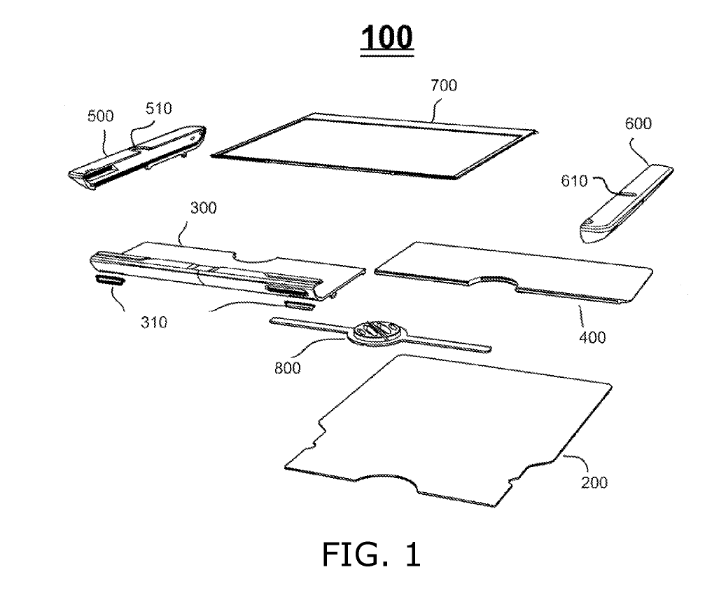

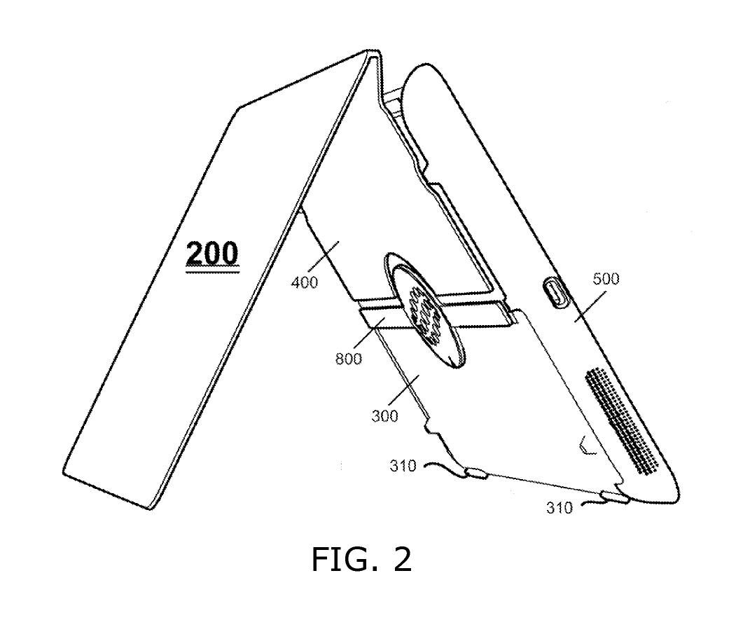

Reference is made to FIG. 1, which is an exploded view of a lenticular lens case 100 for a tablet computer, in accordance with an embodiment of the present invention. Reference is also made to FIG. 2, which is an assembled view of case 100, showing case 100 used as a stand for the tablet computer, in accordance with an embodiment of the present invention.

Case 100 includes two base plates 300 and 400, referred to herein respectively as base plate A and base plate B. Base plates A and B are connected to respective end caps 500 and 600, referred to herein respectively as end cap A and end cap B.

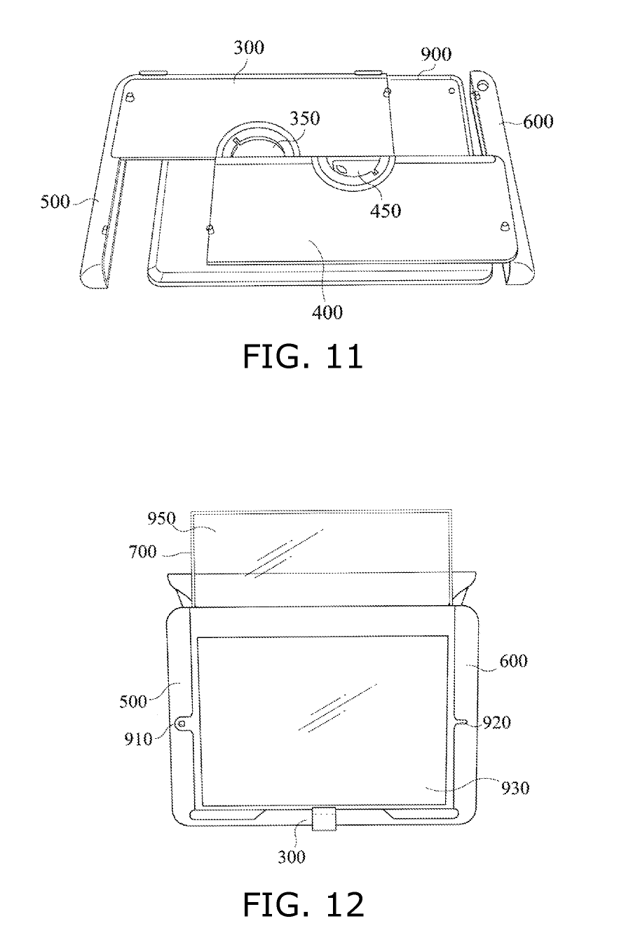

A tablet computer (shown in FIG. 11) is inserted into assembly 100 and fits tightly between end caps A and B. Base plates A and B slide inward and outward relative to one another, to open and closed positions. When the base plates are slid into the open position, there is room for inserting the tablet computer. Then, when the base plates are slid into the closed position, the tablet computer is held tightly in place. A winged bayonet 700 is used to lock the base plates in the closed position, so that the tablet computer remains locked in its place.

When the tablet computer is locked into place it maintains the tablet securely, and enables access to the tablet's hardware device controls and interfaces. Inter alia, as shown in FIG. 1, a button of the tablet computer, such as a home button, is accessible via a cut-out 510 in end cap A, and a camera of the tablet computer is exposed through a cut-out 610 in end cap B.

Assembly 100 includes a lens frame 700, for holding a lenticular lens array (shown in FIG. 12). When the lens array is in use, lens frame 700 is positioned and held in place over the screen of the tablet computer so that the lens array is tightly retained over the screen. Lens frame 600 includes pins that slide up and down tracks within ends caps A and B, to raise and lower the lens frame. When lens frame 700 is raised so that the pins reach the ends of the tracks, then the frame flips substantially 180° over the base plates to the other side of the base plates, for storage when the lens array is not in use. Lens frame 700 is raised and flipped again over the base plates to subsequently use the lens array.

The pixel and sub-pixel structure is analyzed and based on the results, the lenslet width is determined. In the case of an IPAD®, the lenslets are attached to the screen at a 15° angle. As such, the lenslets do not cover each pixel completely, and a pattern like RGB, GBR, BRG, follows a lenslet.

Assembly 100 includes a cover 200, preferably made of a flexible protective material such as leather, which protectively covers the tablet computer. When flipped over the casing to the back of the tablet computer, cover 200 serves as a stand for supporting the tablet computer in a raised position. When used as a stand, cover 200 is in the correct landscape position for using a camera of the tablet computer, and allows for various viewing angles. Rubber grips 310 on base plate A provide grip support for the base plates when the tablet computer is standing in the raised position.

When lens frame is overlaid on the screen of the tablet computer, the lenticular lens is retained tightly over the screen, without an air gap between the lens and the screen. As such, if the screen of the tablet computer is touch-sensitive, then the lenticular lens array supports touch-through sensitivity; i.e., a tap or swipe at a location on the lenticular lens array is detected as a tap or swipe at the corresponding location on the screen of the tablet computer.

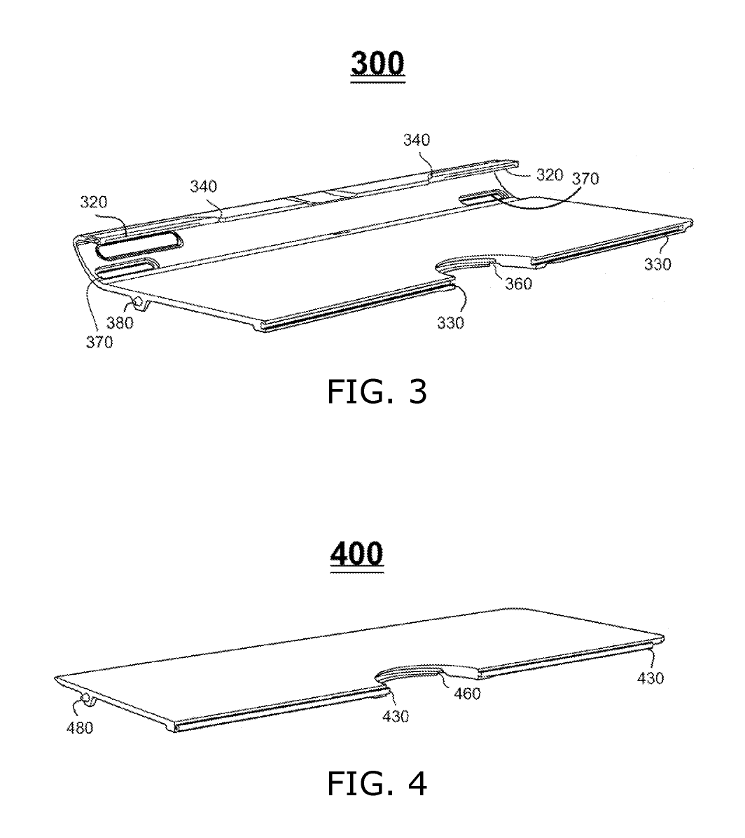

Reference is made to FIG. 3, which is an illustration of base plate A of case 100, in accordance with an embodiment of the present invention. Reference is also made to FIG. 4, which is an illustration of base plate B of case 100, in accordance with an embodiment of the present invention. Base plate A includes magnets 320, molded into the surface of the base plate, for holding lens frame 700 in place when lens frame 700 overlays the screen of the tablet computer. Base plate A has female tracks 330, which slide along counterpart male tracks 430 in base plate B. Tracks 330 and 430 enable the two base plates to slide outward, making room for inserting the tablet computer, and to slide inward to firmly hold the tablet computer in place. Base plate A includes bayonet thread 360, and base plate B includes bayonet thread 460, for locking the base plates in place by turning wing bayonet 800.

Base plate A includes an indent 340 for holding corresponding registration tabs of lens frame 700, to secure lens frame 700 securely in proper alignment when lens frame is overlaid on the screen of the tablet computer. Base plate A includes a grip spaces 370, which are openings in the mold of the base plate into which rubber grips 310 are inserted. Base plate also includes a male boss 380 that fits into a corresponding indent dimple of end cap A, to avoid slippage of the end cap. Similarly, base plate B includes a male boss 480 that fits into a corresponding indent dimple of end cap B, to avoid slippage of the end cap.

Base plate B leaves an open edge space, for storage of lens frame 700 when the lenticular lens array is not in use, as shown below in FIG. 12.

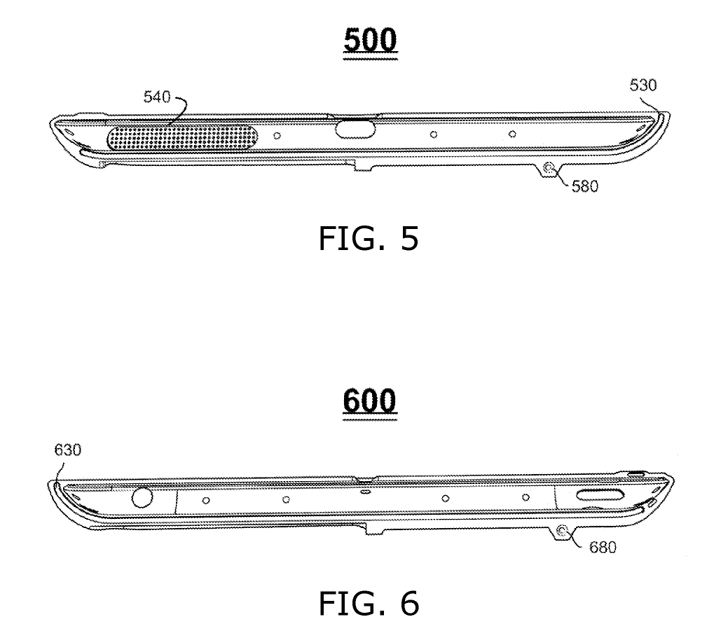

Reference is made to FIG. 5, which is an illustration of end cap A of case 100, in accordance with an embodiment of the present invention. Reference is also made to FIG. 6, which is an illustration of end cap B of case 100, in accordance with an embodiment of the present invention. End cap A has a cut-out 510, for enabling access to a button, such as a home button, of the tablet computer. End cap B has a cut-out 610 for a camera of the tablet computer to see through.

End cap A includes a track 530, and end cap B includes a corresponding track 630. Pins of lens frame 700 slide along tracks 530 and 630 to enable lens frame to move inwards and outwards of case 100. End cap A includes an indent dimple 580 for holding male boss 380 of base plate A, and thereby align base plate A with end cap A. Similarly, end cap B includes an indent dimple 680 for holding male boss 480 of base plate B, and thereby align base plate B with end cap B. End cap A includes a perforation 540, so as to avoid obstructing sound generated by an audio speaker in the tablet computer.

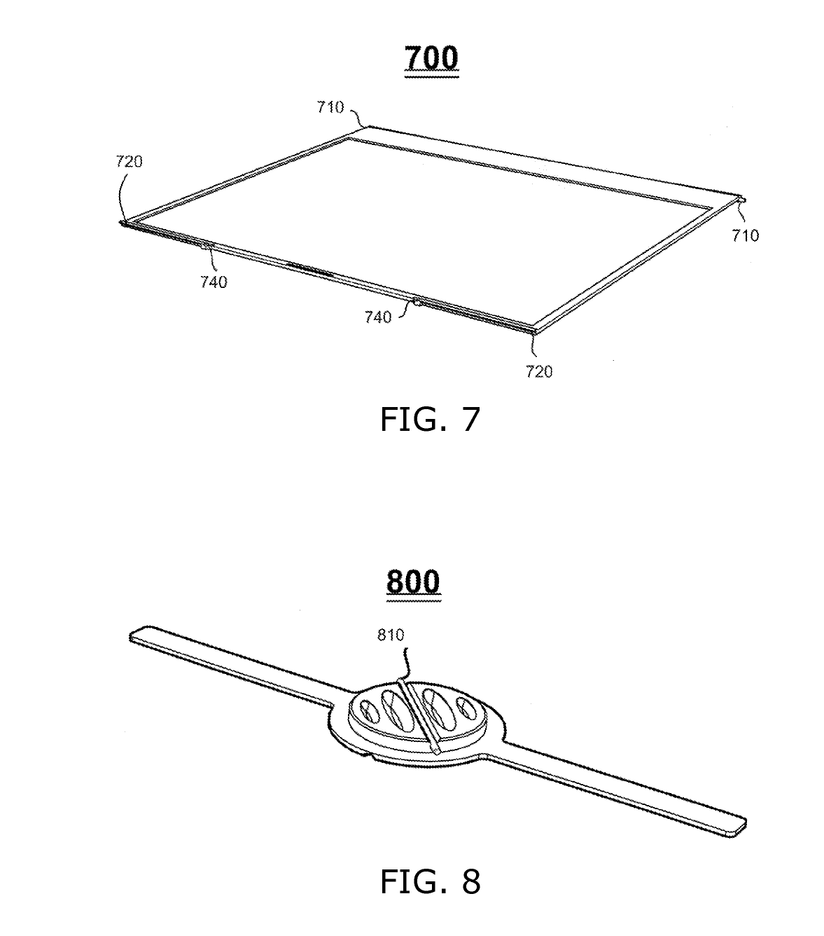

Reference is made to FIG. 7, which is an illustration of lens frame 700 of case 100, in accordance with an embodiment of the present invention. Lens frame 700 includes protruding pins 710, which slide inwards and outwards of tracks 530 and 630 of end caps A and B, to enables lens frame 700 to move inwards and outwards of case 100. Lens frame 700 includes ferrous metal strips 720 which are held by magnets 320 of base plate A. Lens frame 700 also includes registration tabs 740 that fit into indents 340 of base plate A, to secure lens frame 700 securely in proper alignment when lens frame is overlaid on the screen of the tablet computer.

Reference is made to FIG. 8, which is an illustration of wing bayonet 800 for joining base plates A and B, in accordance with an embodiment of the present invention. Wing bayonet 800 includes a metal pin 810 that threads within bayonet threads 350 and 450 of base plates A and B, to lock the base plates into their closed position and thereby secure the tablet computer tightly in place.

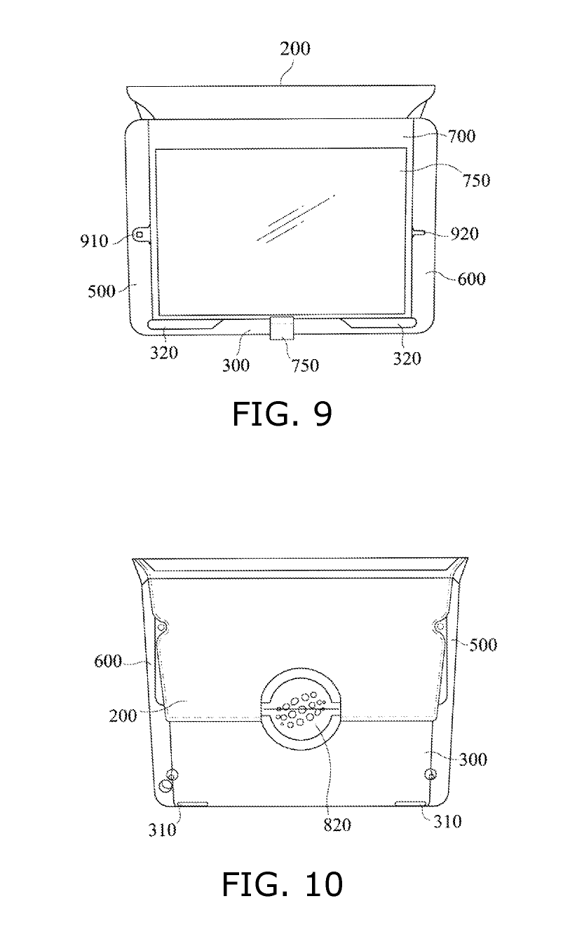

Reference is made to FIG. 9, which is a front perspective view of case 100, in accordance with an embodiment of the present invention. Case 100 is shown with a tablet computer inside. A button 910 of the tablet computer, such as a home button, is accessible through a cut-out of end cap A. A cut-out of end cap B exposes a camera 920 of the tablet computer. A lenticular lens array 950 in lens frame 700 is overlaid on the screen of the tablet computer. A lens removal tab 750 enables a user to pull lens frame 700 away from the screen, when it is no longer in use, for storage inside case 100 behind the tablet computer.

Reference is made to FIG. 10, which is a back perspective view of case 100, in accordance with an embodiment of the present invention. A lock and cover attachment system 820 is used to lock base plates A and B into their closed position, and to attach cover 200. Cover 200 may be sewn around wing bayonet 800, or otherwise assembled around wing bayonet 800. As shown above in FIG. 2, cover 200 may be opened and used as a stand for the tablet computer, and rubber grips 310 provide stability when the tablet computer is standing.

Reference is made to FIG. 11, which is a view of the interlocking base plates and end caps of case 100, in accordance with an embodiment of the present invention. FIG. 11 shows base plate A connected to end cap A, and base plate B connected to end cap B. When the base plates are open, a tablet computer 900 is placed between the base plates. As the base plates move into their closed position, ring 350 of base plate A and ring 450 of base plate B move into alignment for locking. When the base plates are locked into place, tablet computer 900 is tightly held in place between them.

Reference is made to FIG. 12, which is a view of a lenticular lens array 950, in case 100, being stored behind tablet computer 900, in accordance with an embodiment of the present invention. FIG. 12 shows lenticular lens array 950 within lens frame 700. Lens frame 700 is stored behind a screen 930 of tablet computer 900. FIG. 12 shows lens frame 700 in a raised position. Lens frame 700 lowers into case 100 as its pins slide down the tracks of end caps A and B.

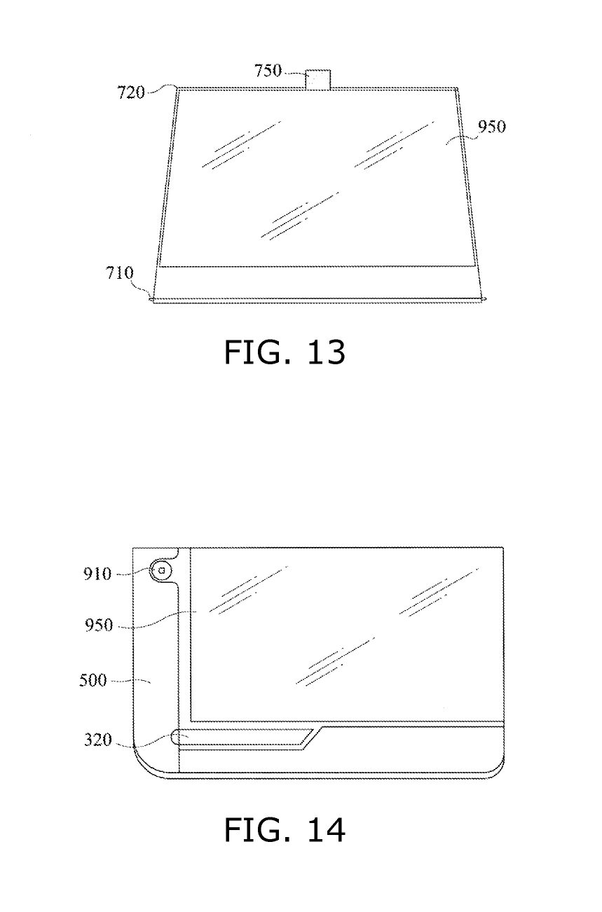

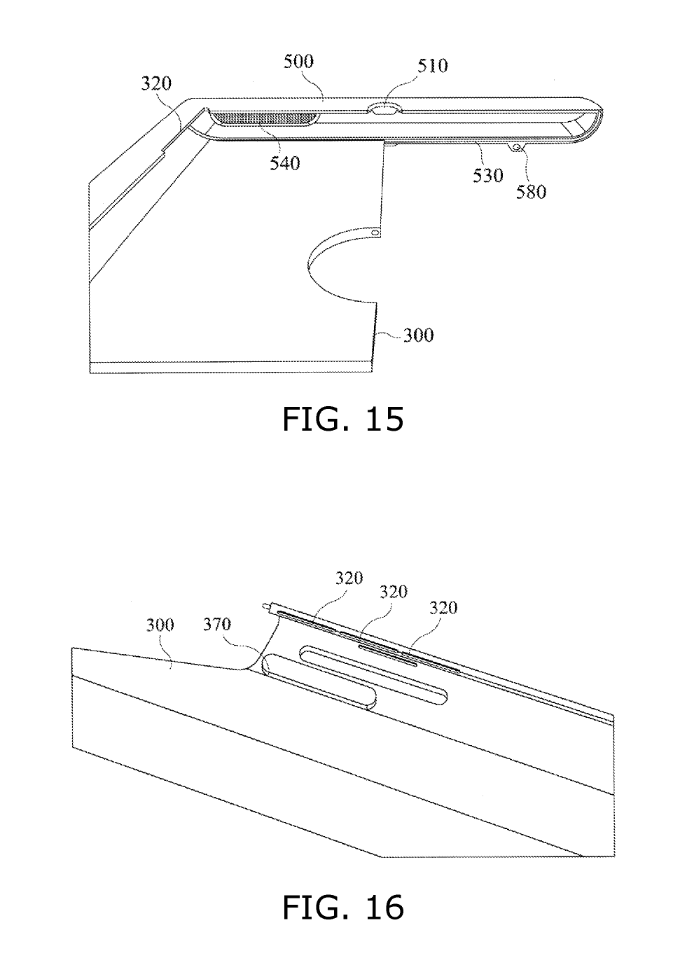

Reference is made to FIG. 13, which is a view of lenticular lens frame 700 of case 100, in accordance with an embodiment of the present invention. Reference is also made to FIG. 14, which is a view of the magnetic alignment mechanism, for aligning and retaining lens frame 700 of case 100, in accordance with an embodiment of the present invention. Reference is further made to FIG. 15, which is a view of the interior of base plate A and end cap A of case 100, in accordance with an embodiment of the present invention. FIG. 15 shows magnets 320 of base plate A and tracks 550 of end cap A. FIG. 13 shows lenticular lens array 950 in lens frame 700. Protruding pins 710 slide up and down the tracks of end caps A and B, to raise and lower lens frame 700 into case 100. When lens frame 700 is lowered into place in front of the screen of the tablet computer, ferrous metal strips 720 are held in place by magnets 320 inside base plate A.

Reference is made to FIG. 16, which is a view of magnets 320 molded in base plate A of case 100, in accordance with an embodiment of the present invention.

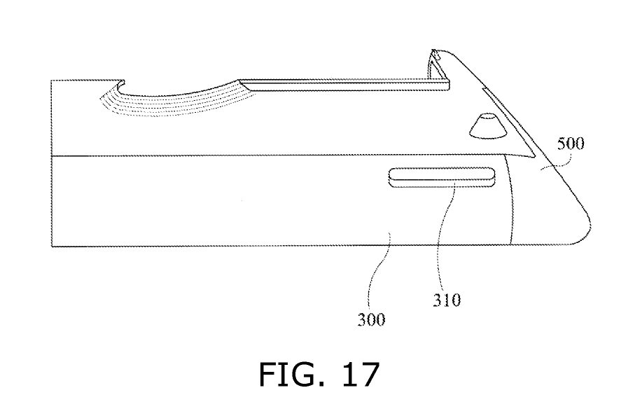

Reference is made to FIG. 17, which is a bottom view of base plate A and end cap A of case 100, in accordance with an embodiment of the present invention. FIG. 17 shows rubber grip 310, which holds case 100 to the ground when case 100 is in a standing position.

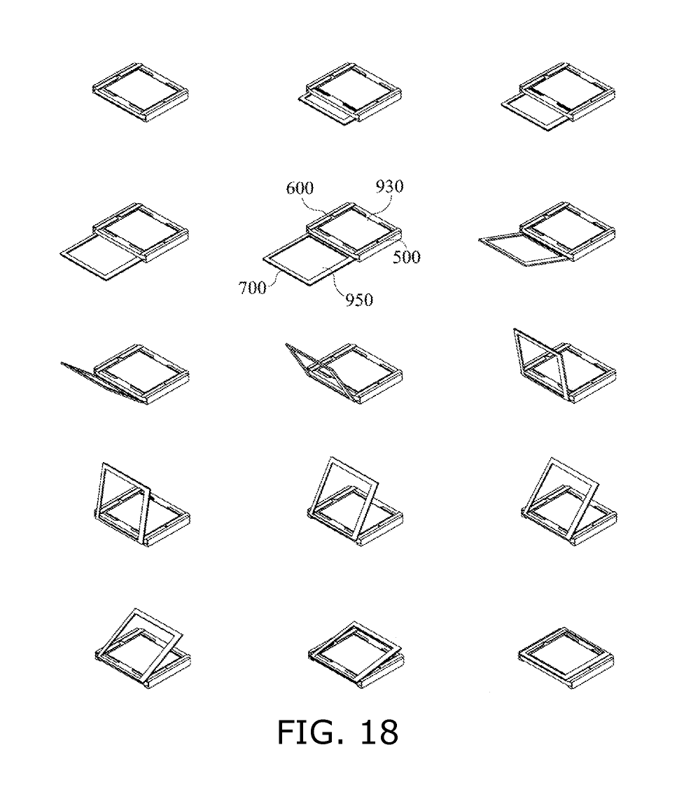

Reference is made to FIG. 18 is an animated sequence of pictures showing how lens frame 700 pulls out and flips over case 100, so as to overlay lenticular lens array 950 on screen 930 of the tablet computer, in accordance with an embodiment of the present invention.

It will thus be appreciated by those skilled in the art that the lenticular lens case for a tablet computer described above overcomes the technical problems of alignment and retention explained above, and provides many other advantages. In particular:
The case provides for accurate, reliable and easy removal and reattachment of a lenticular lens array, with alignment accuracy within 0.01 mm.
The case has a durable attachment system.
The case protects the lenticular lens array in a protected storage position.
The case allows access to hardware controls of the tablet computer.
The case maintains touch-through capabilities of the tablet computer touch screen.
The case is scratch resistant.
The case rejects reflection.

It will be appreciated by those skilled in the art that the present invention has broad application to lenticular lens cases for many devices, in addition to tablet computers. Such devices include inter alia gaming devices, entertainment devices, web browsers, e-readers, mobile phones, and automobile, boat and airplane decks and panels.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A lenticular lens case for a tablet computer, comprising:
first and second base plates that open to enable insertion of a tablet computer, and that close to firmly hold the tablet computer into place;
first and second end caps connected to said first and second base plates, comprising tracks for sliding a frame inwards and outwards; and
a lens frame for holding a lenticular lens array, comprising extruding pins that slide along said tracks, such that when the lens frame is pulled and the pins reach the end of said tracks, the lens frame can be flipped approximately 180° over the base plates so as to tightly retain the lenticular lens array over a screen of the tablet computer, when the tablet computer is firmly locked in said base plates.

2. The case of claim 1, further comprising a cover that flips over one side said base plates to protect the tablet computer, and that flips over the other side of said base plates to provide a supporting stand for the tablet computer, when the tablet computer is firmly locked in said base plates.

3. The case of claim 1 wherein said base plates comprise tracks for sliding relative to one another into open and closed positions, and further comprising a wing bayonet for locking the base plates in the closed position.

4. The case of claim 1 wherein at least one of said base plates comprises a groove for exposing a button of the tablet computer, when the tablet computer is firmly lock in said base plates.

5. The case of claim 1 wherein one of said base plates comprises a groove for exposing a camera lens of the tablet computer, when the tablet computer is firmly locked in said base plates.

6. The case of claim 1 wherein said lens frame comprises one or more ferrous metal strips, and wherein one of said base plates comprises one or more magnets for securely holding said one or more ferrous metal strips in place.

7. The case of claim 1 wherein one of said base plates comprises holes for rubber grips that support the case in a standing position.

8. The case of claim 1 wherein said end caps comprise indentations, and wherein said base plates comprises male bosses that insert into said indentations.

9. The case of claim 1 operable to align the lenticular lens array with the screen of the tablet computer with accuracy of 0.01 mm, when said lenticular frame is flipped over said base plates for the lenticular lens array to overlay the screen.

10. The case of claim 1 operable to provide touch-through capability when the screen of the tablet is touch-sensitive, whereby a tap or swipe on the lenticular lens array is recognized as a tap or swipe on the screen of the tablet, when said lenticular frame is flipped over said base plates for the lenticular lens array to overlay the screen.
